(19) United States
(12) Patent Application Publication
(10) Pub. No.: US 2003/0038902 A1
(43) Pub. Date: Feb. 27, 2003

(54) Liquid-crystal display device having an auxiliary plate for mounting a substrate on a backside lid

(75) Inventor: Eiji Nitto, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/165,760

(22) Filed: Jun. 7, 2002

(30) Foreign Application Priority Data
Aug. 22, 2001 (JP) 2001-251721

(51) Int. Cl. G02F 1/1333

(52) U.S. Cl. 349/58

(57) ABSTRACT

This liquid-crystal display device comprises a substrate, a backside lid, an auxiliary plate, a first mounting mechanism, and a second mounting mechanism. A circuit driving a liquid-crystal panel is provided on the substrate. The backside lid is provided at a backside of the liquid-crystal panel. The auxiliary plate is used for mounting the substrate on the backside lid. The first mounting mechanism is provided at a predetermined position on the backside lid so as to mount the auxiliary plate at the predetermined position on the backside lid. The second mounting mechanism is used for mounting the substrate on the auxiliary plate.

### BACKGROUND OF THE INVENTION

1. Field of the Invention

The present invention generally relates to a liquid-crystal display device, and more particularly, to a liquid-crystal display device having a circuit substrate and so forth provided on a backside lid arranged at a backside of a liquid-crystal panel.

Recently, a liquid-crystal display device is incorporated in various electronic apparatuses and electronic devices, as an output device outputting images, characters and so forth.

Besides, the liquid-crystal display device is provided with a control substrate for driving a liquid-crystal panel. The control substrate has various structures. Thereupon, there is a need for efficiently mounting such a control substrate having different structures on the liquid-crystal display device.

2. Description of the Related Art

Additionally, the liquid-crystal display device is normally provided with a lighting device, such as a backlight, used for realizing a predetermined brightness.

A drive control substrate driving and controlling the liquid-crystal panel of the liquid-crystal display device, and a backlight control substrate controlling the brightness of the backlight are normally provided at a backside of the liquid-crystal display device. Each of the control substrates has various specifications depending on electronic apparatuses and electronic devices incorporating the liquid-crystal display device. Thus, there exist control substrates having various sizes and shapes.

That is, various control substrates having different sizes and shapes are mounted on liquid-crystal panels, depending on electronic apparatuses and devices incorporating the liquid-crystal panels, even when the liquid-crystal panels have identical structures. Conventionally, each of the control substrates is mounted on the liquid-crystal display device by a method of fixing each of the control substrates on a backside lid provided at the backside of the liquid-crystal display device, by using screws.

The backside lid is so arranged as to cover a back surface of the liquid-crystal panel; thereby, the backside lid has a function of increasing a mechanical strength of the liquid-crystal panel. Accordingly, the backside lid essentially needs to be provided unitarily with the liquid-crystal panel.

However, in the above-mentioned conventional method for mounting the control substrates, since each of the control substrates has various forms depending on electronic apparatuses and electronic devices incorporating the liquid-crystal display device, the backside lid needs to be modified according to the various forms. Then, when the backside lid is actually modified, models according as forms of the modified backside lid are added to the liquid-crystal display device. This disadvantageously causes the liquid-crystal display device to be less suitable for mass production. In addition, changes in the control substrates require a variety of the backside lids to be prepared in accordance with the changes; this disadvantageously raises a product cost of the liquid-crystal display device.

### SUMMARY OF THE INVENTION

It is a general object of the present invention to provide an improved and useful liquid-crystal display device in which the above-mentioned problems are eliminated.

A more specific object of the present invention is to provide a liquid-crystal display device which can accommodate various control substrates without modifying a backside lid.

In order to achieve the above-mentioned objects, there is provided according to one aspect of the present invention a liquid-crystal display device comprising:

a substrate having a circuit driving a liquid-crystal panel;

a backside lid provided at a backside of the liquid-crystal panel;

an auxiliary plate so provided as to mount the substrate on the backside lid;

a first mounting mechanism provided at a predetermined position on the backside lid so as to mount the auxiliary plate at the predetermined position; and

a second mounting mechanism so provided as to mount the substrate on the auxiliary plate.

According to the present invention, the auxiliary plate is mounted on the backside lid by the first mounting mechanism. Additionally, the substrate is mounted on the auxiliary plate by the second mounting mechanism. That is, the substrate is mounted on the backside lid with the auxiliary plate therebetween.

In this configuration, the first mounting mechanism is provided at a predetermined position on the backside lid. Accordingly, even when the auxiliary plate has different shapes or sizes, the substrate can be mounted on the backside lid by mounting the auxiliary plate at a position corresponding to the first mounting mechanism, without modifying the backside lid that is unitary with the liquid-crystal panel. Accordingly, changes in shape or size of the substrate do not require a variety of the backside lids to be prepared; instead, the changes in shape or size of the substrate can be dealt with only by modifying the auxiliary plate that is not unitary with the liquid-crystal panel. Thus, changes in the substrate can be dealt with easily at a low cost.

Additionally, in the liquid-crystal display device according to the present invention, the first mounting mechanism may comprise:

a screw mechanism provided in the backside lid;

a through hole formed in the auxiliary plate; and

a screw inserted through the through hole so as to be screwed in the screw mechanism.

Additionally, in the liquid-crystal display device according to the present invention, the first mounting mechanism may comprise:

a through hole formed in the backside lid;

a screw mechanism provided in the auxiliary plate; and

a screw inserted through the through hole so as to be screwed in the screw mechanism.

According to the present invention, simple structures, such as the through hole, the screw and the screw mechanism, can realize the first mounting mechanism; therefore, it costs only a little to realize the liquid-crystal display device that can deal with changes in the substrate.

Additionally, in the liquid-crystal display device according to the present invention, the screw may be screwed in the screw mechanism in a direction parallel with a panel surface of the liquid-crystal panel.

According to the present invention, the screw can be screwed from sides of the liquid-crystal display device. Accordingly, even when the substrate is so large in area as to equal an outline of the liquid-crystal display device, the auxiliary plate can be fixed at the sides with ease.

Additionally, the liquid-crystal display device according to the present invention may further comprise:

a back cover covering at least the substrate from the backside of the liquid-crystal panel,

wherein the substrate, the backside lid and the auxiliary plate are mounted on the back cover all at one time by the first mounting mechanism.

According to the present invention, the substrate, the backside lid and the auxiliary plate can be mounted on the back cover all at one time by the first mounting mechanism; this reduces steps for assembling the liquid-crystal display device.

Other objects, features and advantages of the present invention will become more apparent from the following detailed description when read in conjunction with the accompanying drawings.

### BRIEF DESCRIPTION OF THE DRAWINGS

FIG. 1 is an exploded view of a liquid-crystal display device according to a first embodiment of the present invention;

FIG. 2 is an exploded view of a vicinity of a backside lid of a liquid-crystal display device according to a second embodiment of the present invention; and

FIG. 3 is an exploded view of a vicinity of a backside lid of a liquid-crystal display device according to a third embodiment of the present invention.

### DETAILED DESCRIPTION OF THE PREFERRED EMBODIMENTS

A description will now be given, with reference to the drawings, of embodiments according to the present invention.

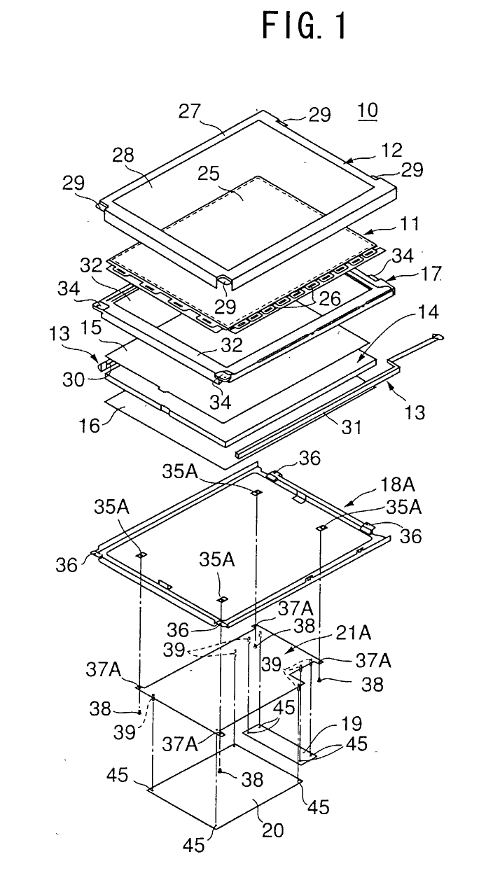

FIG. 1 is an exploded view of a liquid-crystal display device 10 according to a first embodiment of the present invention. The liquid-crystal display device 10 mainly comprises a liquid-crystal panel 11, a facing plate 12, a light-source unit 13, a light-guiding plate 14, a carriage frame 17, a backside lid 18A, an auxiliary plate 21A, a drive control substrate 19, and a backlight control substrate 20.

The liquid-crystal panel 11 comprises a liquid-crystal panel body 25 and a driver 26. Characters, images and so forth are displayed on the liquid-crystal panel body 25. The driver 26 is provided at an outer periphery of the liquid-crystal panel body 25 so as to drive the liquid-crystal panel body 25. The facing plate 12 is placed on the liquid-crystal panel 11.

The facing plate 12 is formed from a metallic material, such as stainless steel (SUS: Steel special Use Stainless), iron, or aluminum, or a resinous material into a boxy-lid shape consisting of a frame portion 27 and an opening portion 28. The facing plate 12 has a function of reinforcing the liquid-crystal panel 11.

The frame portion 27 is so arranged as to oppose the driver 26 provided at the outer periphery of the liquid-crystal panel body 25. The opening portion 28 is so arranged as to oppose the liquid-crystal panel body 25 of the liquid-crystal panel 11.

The carriage frame 17 is placed under the liquid-crystal panel 11. The carriage frame 17 is formed of a resinous molding, such as polycarbonate, or a metallic material, such as stainless steel (SUS) or aluminum. The carriage frame 17 has a function of supporting the liquid-crystal panel 11.

The light-source unit 13 comprises a fluorescent tube 30 and a reflector 31. The light-source unit 13 is so arranged as to oppose sides of the light-guiding plate 14. The fluorescent tube 30 is a light source of the liquid-crystal display device 10. The fluorescent tube 30 is detachably coupled with the reflector 31.

The reflector 31 is composed mainly of a metallic material, such as stainless steel (SUS), iron, or aluminum. The reflector 31 is arranged along the fluorescent tube 30. A silver deposition layer or a white reflective layer is formed on a surface of the reflector 31 opposing the fluorescent tube 30 so as to reflect a light from the fluorescent tube 30 efficiently. Thereby, the light from the fluorescent tube 30 is guided to the light-guiding plate 14 efficiently without being dispersed.

The light-guiding plate 14 is formed of a highly transparent resin, such as an acrylic resin. The light-guiding plate 14 is so placed as to oppose a backside of the liquid-crystal panel 11. An optical sheet 15 is provided on a front surface of the light-guiding plate 14 (a surface opposing the backside of the liquid-crystal panel 11).

The optical sheet 15 has such functions as collecting and diffusing the light emitted from the light-guiding plate 14 so that the light is emitted to the liquid-crystal panel 11 efficiently. Additionally, a reflective sheet 16 is provided on a back surface of the light-guiding plate 14. The reflective sheet 16 has a function of reflecting a light leaking from the light-guiding plate 14 so as to return the light into the light-guiding plate 14.

The backside lid 18A houses the reflector 31, the light-guiding plate 14, the optical sheet 15, the reflective sheet 16, and so forth. The backside lid 18A is formed of a resinous molding, such as polycarbonate, or a metallic material, such as stainless steel (SUS) or aluminum, as is the carriage frame 17.

Screw mechanisms 35A are formed in the backside lid 18A. The screw mechanisms 35A are threaded directly in the backside lid 18A such that hereinafter-described screws 38 are screwed in the respective screw mechanisms 35A. Instead, spacing bolts may be provided such that the screws 38 are screwed in the respective spacing bolts.

Fixation portions 29 are formed at four corners of the facing plate 12. Fixation portions 34 are formed at four corners of the carriage frame 17. Fixation portions 36 are formed at four corners of the backside lid 18A. Each of the fixation portions 29, 34 and 36 has a glossal shape, and has an insertion hole through which a screw is inserted, though not shown in the figure. This screw is screwed with a nut so that the liquid-crystal panel 11, the light-guiding plate 14 and so forth are fixed between the facing plate 12 and the backside lid 18A.

The drive control substrate 19 is a control substrate controlling a screen display of the liquid-crystal panel 11. The backlight control substrate 20 is a substrate controlling the light-source unit 13 (the fluorescent tube 30) so as to maintain a brightness of the liquid-crystal panel 11 at a proper brightness.

Insertion holes 45 are formed at four corners of each of the control substrates 19 and 20. The insertion holes 45 are formed at positions selected not to influence circuits provided on each of the control substrates 19 and 20. Besides, although the drive control substrate 19 and the backlight control substrate 20 are separately provided in the present embodiment, these two substrates may be united as one substrate.

The drive control substrate 19 and the backlight control substrate 20 are mounted on the auxiliary plate 21A. The auxiliary plate 21A is formed of a metallic material, such as stainless steel (SUS) or aluminum, or a resin, such as polycarbonate. Mounting bosses 39 (second mounting mechanisms) are provided on the auxiliary plate 21A for mounting each of the control substrates 19 and 20. The mounting bosses 39 are inserted into the corresponding insertion holes 45 of each of the control substrates 19 and 20 so that each of the control substrates 19 and 20 is mounted on the auxiliary plate 21A.

In this course, each of the control substrates 19 and 20 is demountably mounted on (the mounting bosses 39 of) the auxiliary plate 21A. Therefore, each of the control substrates 19 and 20 can be replaced with ease when each of the control substrates 19 and 20 is out of order; this increases maintainability thereof.

Glossal portions are formed at four corners of the auxiliary plate 21A, and through holes 37A are formed in the respective glossal portions. These through holes 37A are formed at positions corresponding to positions of the screw mechanisms 35A formed in the backside lid 18A. The screws 38 are inserted through the respective through holes 37A, and are screwed in the respective screw mechanisms 35A so that the auxiliary plate 21A is fixed to the backside lid 18A.

In this course, each of the control substrates 19 and 20 is mounted on (the mounting bosses 39 of) the auxiliary plate 21A before or after the auxiliary plate 21A is fixed to the backside lid 18A; thus, each of the control substrates 19 and 20 is also mounted on the backside lid 18A with the auxiliary plate 21A therebetween. Besides, the screw mechanisms 35A, the through holes 37A and the screws 38 constitute a first mounting mechanism.

According to the present embodiment, even when the auxiliary plate 21A has a different shape or size, the auxiliary plate 21A can be mounted on the backside lid 18A by forming the through holes 37A of the auxiliary plate 21A at positions corresponding to positions of the screw mechanisms 35A of the backside lid 18A, without modifying the backside lid 18A that is unitary with the liquid-crystal panel 11.

Additionally, the mounting bosses 39 of the auxiliary plate 21A can be formed at positions determined regardless of the backside lid 18A. Therefore, changes in shape or size of the drive control substrate 19 or the backlight control substrate 20 do not require a variety of the backside lid 18A to be prepared in accordance with the changes.

Therefore, the control substrates 19 and 20 in various shapes and sizes become mountable only by modifying the auxiliary plate 21A. Thus, changes in the control substrates 19 and 20 can be dealt with easily at a low cost. Also, changes in the control substrates 19 and 20 can be dealt without changing a basic configuration of the liquid-crystal display device 10; therefore, the liquid-crystal display device 10 is suitable for mass production.

Besides, in the above-described present embodiment, the screw mechanisms 35A are formed in the backside lid 18A, and the through holes 37A are formed in the auxiliary plate 21A such that the screws 38 are inserted from a back surface of the auxiliary plate 21A through the respective through holes 37A, and are screwed in the respective screw mechanisms 35A. However, the through holes may be formed in the backside lid 18A, and the screw mechanisms may be formed in the auxiliary plate 21A such that the screws 38 are inserted from a front surface of the backside lid 18A through the respective through holes formed in the backside lid 18A, and are screwed in the respective screw mechanisms formed in the auxiliary plate 21A. In whichever arrangement, simple structures, such as the screw mechanisms 35A, the through holes 37A and the screws 38, can realize the first mounting mechanism; therefore, the liquid-crystal display device 10 can be realized at a low cost.

Next, a description will be given of a second embodiment of the present invention.

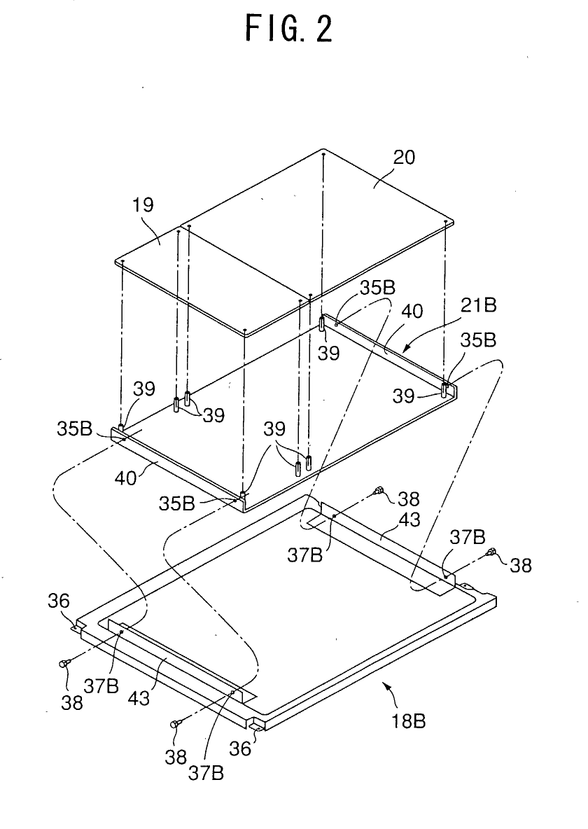

FIG. 2 is an exploded view of a vicinity of a backside lid 18B of a liquid-crystal display device according to the second embodiment of the present invention. Elements in FIG. 2 that are identical or equivalent to the elements shown in FIG. 1 are referenced by the same reference marks, and will not be described redundantly in detail. Also in the present second embodiment, the liquid-crystal panel 11, the facing plate 12, the light-source unit 13, the light-guiding plate 14 and so forth are provided on the backside lid 18A; however, since these elements have the same structures as in the liquid-crystal display device 10 according to the foregoing first embodiment, these elements are not redundantly shown in FIG. 2.

In the present second embodiment, bent portions 43 are formed at both sides (in a longitudinal direction) of the backside lid 18B, and through holes 37B are formed in the bent portions 43. Additionally, bent portions 40 are formed at both sides of an auxiliary plate 21B, and screw mechanisms 35B are formed in the bent portions 40.

Further, the auxiliary plate 21B is mounted between a pair of the bent portions 43 formed on the backside lid 18B, and the drive control substrate 19 and the backlight control substrate 20 are mounted between a pair of the bent portions 40 formed on the auxiliary plate 21B. Besides, it is arranged that the screw mechanisms 35B coincide with the corresponding through holes 37B in a state where the auxiliary plate 21B is mounted between the bent portions 43 formed on the backside lid 18B.

In this mount state, the screws 38 are screwed into the respective screw mechanisms 35B via the respective through holes 37B in a direction parallel with a panel plane of the liquid-crystal panel 11 (i.e., parallel with an in-plane direction of the backside lid 18B). Thus, the screws 38 are screwed from sides of the backside lid 18B (of the liquid-crystal display device); this secures a wide area on the auxiliary plate 21B. Therefore, even when the control substrates 19 and 20 are so large in area as to cover a whole surface of the backside lid 18B, the auxiliary plate 21B can be fixed to (the backside lid 18B) of the liquid-crystal display device without protruding from an outline of the liquid-crystal display device.

Next, a description will be given of a third embodiment of the present invention.

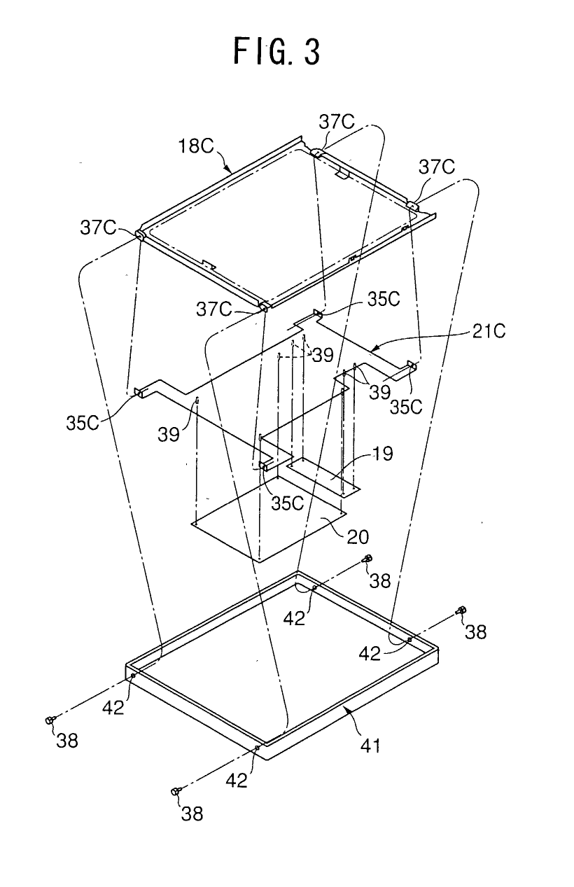

FIG. 3 is an exploded view of a vicinity of a backside lid 18C of a liquid-crystal display device according to the third embodiment of the present invention. Elements in FIG. 3 that are identical or equivalent to the elements shown in FIG. 1 are referenced by the same reference marks, and will not be described redundantly in detail. Also, the liquid-crystal panel 11, the facing plate 12, the light-source unit 13, the light-guiding plate 14 and so forth are not redundantly shown in FIG. 3.

The present third embodiment is characterized in that the backside lid 18C is mountable on a back cover 41. The back cover 41 has a boxy-lid shape, and is formed of a metallic material, such as stainless steel (SUS), iron, or aluminum, or a resinous material. The back cover 41 has a function of covering and protecting the drive control substrate 19 and the backlight control substrate 20 from the back.

In the present third embodiment, glossal portions are formed at four corners of the backside lid 18C such that each of the glossal portions is bent perpendicularly, and through holes 37C are formed in the respective glossal portions. Additionally, perpendicularly bent glossal portions are formed at four corners of an auxiliary plate 21C, and screw mechanisms 35C are formed in the respective glossal portions. Further, through holes 42 are formed at four corners of the back cover 41.

In the course of assembling the liquid-crystal display device according to the present third embodiment, after each of the control substrates 19 and 20 is mounted on the mounting bosses 39 provided on the auxiliary plate 21C, the auxiliary plate 21C is mounted on the back cover 41. Subsequently, the backside lid 18C is mounted on the back cover 41 over the auxiliary plate 21C. In this mount state, the backside lid 18C, the auxiliary plate 21C and the back cover 41 are so arranged that the through holes 42 of the back cover 41, the through holes 37C of the backside lid 18C, and the screw mechanisms 35C of the auxiliary plate 21C are located in this order from outside.

Accordingly, the backside lid 18C, the auxiliary plate 21C and the back cover 41 can be fixed to one another all at one time by screwing the screws 38 from outside of the back cover 41 via the respective through holes 42 and the respective through holes 37C into the respective screw mechanisms 35C. This reduces steps for assembling the liquid-crystal display device.

Additionally, the screws 38 are screwed from sides of the back cover 41; thus, the screws 38 can be screwed with simplicity. Further, in the present embodiment, since the first mounting mechanism is used to fix not only the backside lid 18C and the auxiliary plate 21C but also the back cover 41, the liquid-crystal panel 11 is mounted on back cover 41 with augmented strength so as to increase a strength of the liquid-crystal display device as a whole.

The present invention is not limited to the specifically disclosed embodiments, and variations and modifications may be made without departing from the scope of the present invention.

The present application is based on Japanese priority application No. 2001-251721 filed on Aug. 22, 2001, the entire contents of which are hereby incorporated by reference.

What is claimed is:

1. A liquid-crystal display device comprising:
a substrate having a circuit driving a liquid-crystal panel;
a backside lid provided at a backside of said liquid-crystal panel;
an auxiliary plate so provided as to mount said substrate on said backside lid;
a first mounting mechanism provided at a predetermined position on said backside lid so as to mount said auxiliary plate at said predetermined position; and
a second mounting mechanism so provided as to mount said substrate on said auxiliary plate.

2. The liquid-crystal display device as claimed in claim 1, wherein said first mounting mechanism comprises:
a screw mechanism provided in said backside lid;
a through hole formed in said auxiliary plate; and
a screw inserted through said through hole so as to be screwed in said screw mechanism.

3. The liquid-crystal display device as claimed in claim 1, wherein said first mounting mechanism comprises:
a through hole formed in said backside lid;
a screw mechanism provided in said auxiliary plate; and
a screw inserted through said through hole so as to be screwed in said screw mechanism.

4. The liquid-crystal display device as claimed in claim 2, wherein said screw is screwed in said screw mechanism in a direction parallel with a panel surface of said liquid-crystal panel.

5. The liquid-crystal display device as claimed in claim 3, wherein said screw is screwed in said screw mechanism in a direction parallel with a panel surface of said liquid-crystal panel.

6. The liquid-crystal display device as claimed in claim 1, further comprising:
a back cover covering at least said substrate from the backside of said liquid-crystal panel,
wherein said substrate, said backside lid and said auxiliary plate are mounted on said back cover all at one time by said first mounting mechanism.

7. The liquid-crystal display device as claimed in claim 2, further comprising:
a back cover covering at least said substrate from the backside of said liquid-crystal panel,
wherein said substrate, said backside lid and said auxiliary plate are mounted on said back cover all at one time by said first mounting mechanism.

8. The liquid-crystal display device as claimed in claim 3, further comprising:
a back cover covering at least said substrate from the backside of said liquid-crystal panel,
wherein said substrate, said backside lid and said auxiliary plate are mounted on said back cover all at one time by said first mounting mechanism.

9. The liquid-crystal display device as claimed in claim 4, further comprising:
a back cover covering at least said substrate from the backside of said liquid-crystal panel,
wherein said substrate, said backside lid and said auxiliary plate are mounted on said back cover all at one time by said first mounting mechanism.

10. The liquid-crystal display device as claimed in claim 5, further comprising:
a back cover covering at least said substrate from the backside of said liquid-crystal panel,
wherein said substrate, said backside lid and said auxiliary plate are mounted on said back cover all at one time by said first mounting mechanism.
